(19) United States
(12) Patent Application Publication
(10) Pub. No.: US 2009/0002916 A1
(43) Pub. Date: Jan. 1, 2009

(54) Interdigital capacitor

(75) Inventors: Chang Lin Wei, Hsinchu (TW); Chin Sun Shyu, Hsinchu (TW); Cheng Hua Tsai, Hsinchu (TW); Min Lin Lee, Hsinchu (TW)

Correspondence Address: VENABLE LLP, P.O. BOX 34385, WASHINGTON, DC, 20043-9998, US

(73) Assignee: INDUSTRIAL TECHNOLOGY RESEARCH INSTITUTE, Hsinchu (TW)

(21) Appl. No.: 11/987,756

(22) Filed: Dec. 4, 2007

(30) Foreign Application Priority Data
Jun. 27, 2007 (TW) 96123306

(51) Int. Cl. H01G 4/005

(52) U.S. Cl. 361/303

(57) ABSTRACT

An interdigital capacitor includes a first finger electrode structure and a second finger electrode structure. The first finger electrode structure has a first electrode and a plurality of first extending electrodes. The first extending electrodes are linearly disposed and arranged. The second finger electrode structure has a second electrode and a plurality of second extending electrodes. The second extending electrodes are linearly disposed and arranged. The second finger electrode structure interlaces with the first finger electrode structure. At least one pair of first coupling electrodes extend respectively from the neighboring first and second extending electrodes and are disposed between them.

### FIELD OF THE INVENTION

The present invention relates to a capacitor, and more particularly to an interdigital capacitor.

### BACKGROUND OF THE INVENTION

In an age where products of computers, communications and consumer electronics become more and more popular, consumer behavior has been an important factor that dominates the trend of product design. Nowadays, consumer electronic devices have almost become a part integrated to the human body; contents of various formats can be accessed through these electronic devices emphasizing great convenience, low power consumption, compact size and low cost. For portable or wearable electronic devices, there are often needs for products that endure bending or curving by customers, and thus, it is necessary to apply flexible circuits into these products.

It is known that capacitors are widely used in circuit boards, and most of the capacitors are soldered to circuit boards through a complicated manufacturing process such as surface mount techniques (SMTs). Although capacitors have generally become downsized, multiple layers of substrates are still needed to construct a circuit board, which results in an increase of area and height of physical circuits. Recently, many research institutes have endeavored to develop different capacitor materials that enable capacitors to be embedded in multi-layer circuit substrates, and some materials have been successfully applied to circuits of various electronic devices.

Board bending uses frequently occur to capacitors embedded in wearable or portable electronic devices. Conventional design for an interdigital capacitor includes coupling electrodes of only one direction. As shown in FIG. 1, a conventional interdigital capacitor 200 comprises a first finger electrode structure 30, which includes a first electrode 31 and a plurality of first extending electrodes 32 extending from the first electrode 31, each of the first extending electrodes 32 paralleling one another; the conventional interdigital capacitor 200 also comprises a second finger electrode structure 40, which includes a second electrode 41 and a plurality of second extending electrodes 42 extending from the second electrode 41, each of the second extending electrodes 42 paralleling one another. Moreover, the second finger electrode structure 40 interlaces with the first finger electrode structure 30.

When a conventional interdigital capacitor encounters an external force that bends its electrode plates, the capacitive characteristics are subject to change in accordance with the direction of bending axis since the capacitor includes coupling electrodes of one direction only.

Thus, it is quite an urgent demand for the industry to provide an interdigital capacitor that has more stable capacitive characteristics after being bent.

### SUMMARY OF THE INVENTION

The present invention provides an interdigital capacitor structure having coupling electrodes of more than one direction in order to enhance the stability of capacitance.

The present invention provides an interdigital capacitor comprising a first finger electrode structure, which includes a first electrode and a plurality of first extending electrodes extending from the first electrode, the first extending electrodes being linearly disposed and arranged; the interdigital capacitor also comprises a second finger electrode structure, which includes a second electrode and a plurality of second extending electrodes extending from the second electrode, the second extending electrodes being linearly disposed and arranged. Moreover, the second finger electrode structure interlaces with the first finger electrode structure, wherein at least one pair of coupling electrodes extend respectively from the neighboring first and second extending electrodes, and the pair of coupling electrodes are disposed between the neighboring extending electrodes.

### BRIEF DESCRIPTION OF THE DRAWINGS

FIG. 1 is a schematic drawing of a conventional interdigital capacitor.

FIG. 2 is a schematic drawing of an interdigital capacitor according to a first embodiment of the present invention.

FIG. 3 is a schematic drawing of an interdigital capacitor according to a second embodiment of the present invention.

FIG. 4 is a schematic drawing of an interdigital capacitor according to a third embodiment of the present invention.

FIG. 5 is a schematic drawing of an interdigital capacitor according to a fourth embodiment of the present invention.

FIG. 6 is a schematic drawing of an interdigital capacitor according to a fifth embodiment of the present invention.

### DETAILED DESCRIPTION OF THE INVENTION

The interdigital capacitor of one embodiment of the present invention is disposed on the surface of a coplanar substrate, comprising a first finger electrode structure, which includes a first electrode and a plurality of first extending electrodes extending from the first electrode, the first extending electrodes being linearly disposed and arranged; the interdigital capacitor also comprises a second finger electrode structure, which includes a second electrode and a plurality of second extending electrodes extending from the second electrode, the second extending electrodes being linearly disposed and arranged. Moreover, the second finger electrode structure interlaces with the first finger electrode structure, wherein at least one pair of first coupling electrodes extend respectively from the neighboring first and second extending electrodes, and the coupling electrodes are disposed between the neighboring extending electrodes. The present invention enables an interdigital capacitor to comprise coupling electrodes of more than two directions at a time when it is bent towards different directions; thus, it can be applied to wearable or portable electronic devices and still keeps its capacitive characteristics stable after being bent. The variations on electrical characteristics can be minimized by employing an interdigital capacitor of the present invention. The following will describe different embodiments of the present invention in greater detail.

Referring to FIG. 2, a schematic drawing of an interdigital capacitor according to a first embodiment of the present invention is shown. The interdigital capacitor 100 of the first embodiment is disposed on the surface of a coplanar substrate or within a substrate (not shown), comprising a first finger electrode structure 10, which includes a first electrode 11 and a plurality of first extending electrodes 12 extending from the first electrode 100 each of the first extending electrodes 12 paralleling one another; the interdigital capacitor 100 also comprises a second finger electrode structure 20, which includes a second electrode 21 and a plurality of second extending electrodes 22 extending from the second electrode 21, each of the second extending electrodes 22 paralleling one another. Moreover, the second finger electrode structure 20 interlaces with the first finger electrode structure 10.

A plurality of pairs of first coupling electrodes 13 extend, respectively and vertically, from each of the first extending electrodes 12 and from each of the second extending electrodes 22; each pair of first coupling electrodes 13 parallel another pair and form a coupling along the X-direction (vertically). A plurality of pairs of second coupling electrodes 23 extend, respectively and vertically, from each of the first extending electrodes 12 and from each of the second extending electrodes 22. Each pair of second coupling electrodes 23 interlace with another pair and are disposed between the first extending electrode 12 and the second extending electrode 22 to form a coupling along the Y-direction (horizontally). Furthermore, the first coupling electrodes 13 interlace with the second coupling electrodes 23, and both coupling electrodes are disposed between the first extending electrode 12 and the second extending electrode 22.

In this embodiment, the substrate can be, for example, a printed circuit substrate, a ceramic substrate, an integrated circuit substrate, or a substrate composed of multiple stacked dielectric materials, and the shapes of first coupling electrodes 13 or second coupling electrodes 23 can be, for example, square or rectangular.

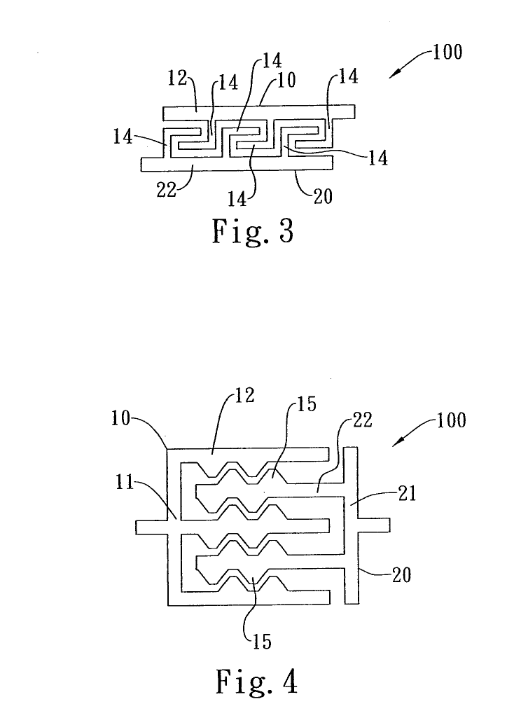

Referring to FIG. 3, a schematic drawing of an interdigital capacitor according to a second embodiment of the present invention is shown. The structure of the interdigital capacitor in this embodiment is approximately identical with that in the first embodiment. One difference, for example, is that in the second embodiment, a plurality of L-shaped coupling electrodes 14 extend vertically from the first extending electrode 12 and from the second extending electrode 22, wherein the L-shaped coupling electrodes 14 are disposed in a corresponding manner.

Referring to FIG. 4, a schematic drawing of an interdigital capacitor according to a third embodiment of the present invention is shown. The structure of the interdigital capacitor in this embodiment is approximately identical with that in the first embodiment. One difference, for example, is that in the third embodiment, a plurality of taper-shaped coupling electrodes 15 extend from the first extending electrode 12 and from the second extending electrode 22, wherein the taper-shaped coupling electrodes 15 are disposed in an interlacing manner.

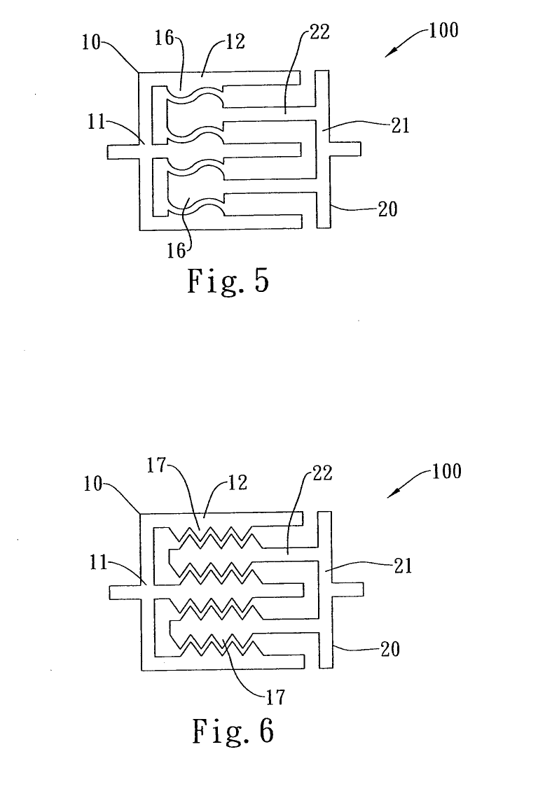

Referring to FIG. 5, a schematic drawing of an interdigital capacitor according to a fourth embodiment of the present invention is shown. The structure of the interdigital capacitor in this embodiment is approximately identical with that in the first embodiment. One difference, for example, is that in the fourth embodiment, a plurality of wavy-shaped coupling electrodes 16 extend from the first extending electrode 12 and from the second extending electrode 22, wherein the wavy-shaped coupling electrodes 16 are disposed with one concave electrode and one convex electrode.

Referring to FIG. 6, a schematic drawing of an interdigital capacitor according to a fifth embodiment of the present invention is shown. The structure of the interdigital capacitor in this embodiment is approximately identical with that in the first embodiment. One difference, for example, is that in the fifth embodiment, a plurality of triangular-shaped coupling electrodes 17 extend from the first extending electrode 12 and from the second extending electrode 22, wherein the triangular-shaped coupling electrodes 17 are disposed in an interlacing manner.

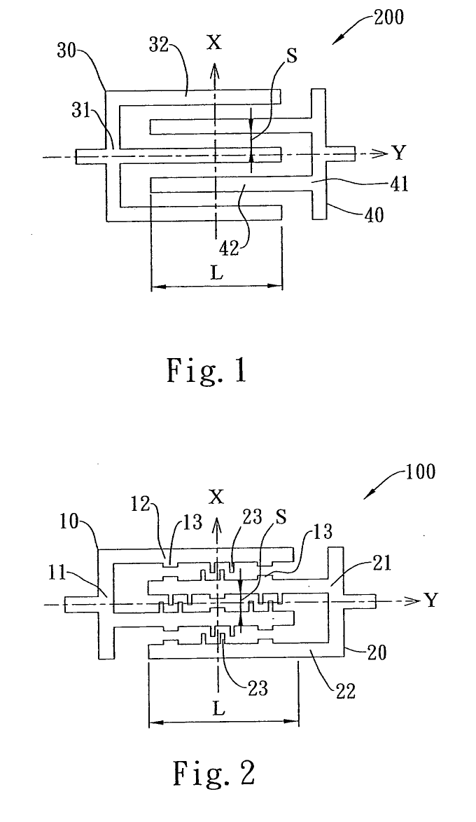

Compared to the conventional interdigital capacitor shown in FIG. 1, the interdigital capacitor of the present invention provides more stable capacitance when the substrate is being bent. What follows will take the conventional interdigital capacitor shown in FIG. 1 as an example to demonstrate the variation on electrical characteristics when the substrate is being bent. The capacitive characteristics of a conventional interdigital capacitor, when the capacitor encounters an external force that bends its electrode plates, are subject to change to an extent in accordance with the direction of bending. That is, it matters a lot to the capacitive characteristics whether the bending axis is vertical or parallel to the electrode plates. A conventional interdigital capacitor has its capacitance generated from the coupling electrodes along an X-direction, and the major parameters that influence the capacitance C of the interdigital capacitor are the distance S between electrode plates and the length L of each electrode plate (the amount of coupling on the finger tip region between the first electrode 31 and the second extending electrode 42, or between the second electrode 41 and the first extending electrode 32 are very little; the influence is accordingly little and can thus be ignored hereinafter), wherein:

C=f(S,L),

We define ΔC as the variation of the capacitance.

$$Δ C = {( \frac{Δ C}{Δ S} )}_{Δ L = 0} Δ S + {( \frac{Δ C}{Δ L} )}_{Δ S = 0} Δ L$$

(1) when the substrate is not being bent, ΔC=0, C □ C_{un-bend};
(2) when the substrate is being bent along an orthogonal base in two-dimensional space, e.g., along Y axis, the distance S is increased (the length L remains constant), and accordingly, the overall capacitance is decreased. The capacitance at this time is C_{Trad.,Y-bend}.

$$Δ {C}_{Trad . , Y \text{-} bend} = {( \frac{Δ C}{Δ S} )}_{Δ L = 0} Δ S$$

$$since , ( \frac{Δ C}{Δ S} ) < 0 and Δ S > 0$$

then, ΔC_{Trad.,Y-bend}<0

C_{Trad.,Y-bend}=C_{un-bend}+ΔC_{Trad.,Y-bend}<C_{un-bend}

and C_{min.}≦C_{Trad.,Y-bend}<C_{un-bend} wherein C_{min.} is the absolute minimum value of capacitance bent along Y axis;
(3) when the substrate is bent along another orthogonal base in two-dimensional space, e.g., along X axis, the length L is increased (the distance S remains constant), and accordingly, the overall capacitance is increased. The capacitance at this time is C_{Trad.,X-bend}.

$$Δ {C}_{Trad . , Y \text{-} bend} = {( \frac{Δ C}{Δ L} )}_{Δ S = 0} Δ L$$

$$since , ( \frac{Δ C}{Δ L} ) > 0 and Δ L > 0$$

then, ΔC_{Trad.,X-bend}>0

C_{Trad.,X-bend}=C_{un-bend}+ΔC_{Trad.,X-bend}>C_{un-bend}

and C_{un-bend}≦C_{Trad.,X-bend}<C_{max.}, wherein C_{max.} is the absolute maximum value of capacitance bent along X axis.

From (2) and (3), that the range of capacitance is ΔC_{Trad,bend} when the conventional interdigital capacitor is bent along X axis or Y axis is:

ΔC_{Trad,bend}=|C_{max.}−C_{min.}|

The interdigital capacitor of the present embodiment employs coupling electrodes of more than one direction, and thus results in more stable capacitance when the substrate is bent. What follows will take the interdigital capacitor of the present invention shown in FIG. 2 as an example to demonstrate the variation on electrical characteristics when the substrate is bent. The interdigital capacitor in this embodiment has coupling electrodes of Y direction and X direction. Hence, the distance S and the length L may change simultaneously when the capacitor is bent along Y axis or X axis,

and since

$$( \frac{Δ C}{Δ S} ) < 0 , Δ S > 0 , ( \frac{Δ C}{Δ L} ) > 0 , Δ L > 0$$

Therefore, compensation occurs to the capacitance (C_{New,bend}) after the capacitor is bent, due to the change of distance S and length L; the range of capacitance now is ΔC_{New,bend}. In practice, the number of coupling electrodes along Y direction and X direction can be adjusted so as to make ΔC_{New,bend}=0, which means the capacitance remains the same after the capacitor is bent. On the other hand, the number of coupling electrodes can be adjusted so as to make ΔC_{New,bend}<ΔC_{Trad,bend}, which means the capacitance remains relatively stable after the capacitor is bent.

In the above-mentioned embodiment, the interdigital capacitor is a type of interdigital capacitor which can be embedded within a substrate. The couplings therein are not in one direction, and therefore, the capacitor can have coupling electrodes of more than two directions at the same time. This enables the interdigital capacitor to have more stable capacitive characteristics and less variation on electrical characteristics after being bent. Also, this feature can prevent the high-frequency characteristics of a capacitor from changing vastly, which results in impedance mismatch that may influence electrical performance of a system module. Since capacitors are widely used in high-frequency circuits such as those applied to low noise amplifiers, variable-gain amplifiers and power amplifiers, the overall performance of system circuits can be improved if impedance mismatches are reduced. The interdigital capacitors of the present embodiments, then, can be further applied to a variety of modules or products with flexible high-frequency circuits.

With the interdigital capacitor of the present embodiments, the number and shape of the coupling electrodes can be adjusted according to the bending direction of the substrate. This enables the capacitor to have more stable capacitive characteristics and less variation on electrical characteristics; the feature overcomes disadvantages of a conventional interdigital capacitor which includes a coupling electrode structure of only a single direction. The capacitive characteristics of a conventional interdigital capacitor is subject to change in accordance with the bending direction, which may result in a vast change in electrical characteristics when the electrode structure encounters an external bending force.

The aforementioned embodiments of the present invention would be understood by those skilled in the art. Any change or modification or the equivalent thereof can be made without departing from the spirit of the following claims. Moreover, the present invention is not limited within the scope of the aforementioned embodiments. For example, the coupling electrodes extending from the first extending electrode and the second extending electrode of the present embodiments can be provided in different shapes or numbers based on the actual needs; the plurality of coupling electrodes can be, for example, geometric-shaped like rectangular-shaped, circular-shaped, triangular-shaped, taper-shaped or oval-shaped; and the plurality of first extending electrodes and second extending electrodes can be disposed in a parallel or non-parallel manner.

What is claimed is:

1. An interdigital capacitor, comprising:
a first finger electrode structure which includes a first electrode and a plurality of first extending electrodes extending from said first electrode, the first extending electrodes being linearly disposed and arranged;
a second finger electrode structure which includes a second electrode and a plurality of second extending electrodes extending from said second electrode, the second extending electrodes being linearly disposed and arranged, wherein said second finger electrode structure interlaces with said first finger electrode structure; and
at least one pair of first coupling electrodes extending respectively from the neighboring first and second extending electrodes, being disposed between said first and second extending electrodes.

2. The interdigital capacitor of claim 1, wherein the capacitor is disposed on any one of: the surface of a coplanar substrate, and within a substrate, said substrate being a printed circuit substrate, a ceramic substrate, or an integrated circuit substrate.

3. The interdigital capacitor of claim 1, wherein the capacitor is disposed on any one of: the surface of a coplanar substrate, and within a substrate, said substrate being composed of multiple stacked dielectric materials.

4. The interdigital capacitor of claim 1, wherein the plurality of first extending electrodes and the plurality of second extending electrodes are parallel to one another.

5. The interdigital capacitor of claim 1, wherein the plurality of first extending electrodes and the plurality of second extending electrodes are not parallel to one another.

6. The interdigital capacitor of claim 1, wherein the at least one pair of first coupling electrodes are geometric-shaped.

7. The interdigital capacitor of claim 6, wherein the at least one pair of first coupling electrodes can be any one of: rectangular-shaped, triangular-shaped, taper-shaped, circular-shaped, and oval-shaped.

8. The interdigital capacitor of claim 1, wherein at least one pair of first coupling electrodes are any one of: wavy-shaped and L-shaped.

9. The interdigital capacitor of claim 1, wherein one electrode of the first coupling electrodes parallels the other electrode of the first coupling electrodes, and the first coupling electrodes extend respectively from the first extending electrode and from the second extending electrode.

10. The interdigital capacitor of claim 1, wherein a pair of second coupling electrodes extend respectively and vertically from the first extending electrode and from the second extending electrode.

11. The interdigital capacitor of claim 1, wherein one electrode of the first coupling electrodes parallels the other electrode of the first coupling electrodes, and a pair of second coupling electrodes extend respectively and vertically from the first extending electrode and from the second extending electrode.

12. The interdigital capacitor of claim 10, wherein the second coupling electrodes are disposed between the first extending electrode and the second extending electrode in an interlacing manner.

13. The interdigital capacitor of claim 11, wherein the second coupling electrodes are disposed between the first extending electrode and the second extending electrode in an interlacing manner.

14. The interdigital capacitor of claim 11, wherein the first coupling electrodes interlace with the second coupling electrodes and both the first and second coupling electrodes are disposed between the first extending electrode and the second extending electrode.

15. The interdigital capacitor of claim 1, wherein the at least one pair of coupling electrodes comprises a plurality of taper-shaped coupling electrodes disposed in an interlacing manner.

16. The interdigital capacitor of claim 1, wherein the at least one pair of the coupling electrodes comprises a plurality of wavy-shaped coupling electrodes disposed with one concave electrode and one convex electrode.

17. The interdigital capacitor of claim 1, wherein the at least one pair of the coupling electrodes comprises a plurality of triangular-shaped coupling electrodes disposed in an interlacing manner.
